(19) United States
(12) Patent Application Publication
(10) Pub. No.: US 2006/0045431 A1
(43) Pub. Date: Mar. 2, 2006

(54) Integrated fiber alignment photodetector

(76) Inventors: Joseph C. Boisvert, Thousand Oaks, CA (US); Anastacio S. Paredes, Santa Paula, CA (US)

Correspondence Address: Jonathan W. Hallman;MacPHERSON KWOK CHEN & HEID LLP, Suite 226, 1762 Technology Drive, San Jose, CA, 95110, US

(21) Appl. No.: 10/925,707

(22) Filed: Aug. 24, 2004

(51) Int. Cl. G02B 6/36

(52) U.S. Cl. 385/88

(57) ABSTRACT

An integrated fiber alignment photodetector is provided by forming a plurality of photodiodes on a first substrate. A corresponding plurality of through holes are formed in a second substrate, which is then aligned to the first substrate and bonded thereto to form a fiber alignment photodetector assembly. Individual fiber alignment photodiodes may then be diced from the assembly. The through hole on each individual fiber alignment photodiode provides a guide for the insertion of an optical fiber, which may then be bonded within the through hole to complete a fiber alignment photodetector.

### TECHNICAL FIELD

This invention relates generally to optical communications, and more particularly to the alignment of optical fibers to photodetectors.

### BACKGROUND

As compared to traditional communication mediums such as twisted pair or coaxial cable, optical fibers provide much greater data-carrying capacity. Many data-carrying channels, each centered on its own wavelength may be multiplexed onto a single optical fiber using, for example, dense wavelength division multiplexing. Data represented by optical signals on the fiber must be converted into electrical form by a fiber optic detector before it may be received by a user.

Fiber optic detectors include a photodetector such as a PIN phototodiode or an avalanche photodiode to convert the received optic signal into an electrical signal. PIN photodiodes are favored for low-speed data traffic whereas avalanche photodiodes are favored for high-speed data traffic. Regardless of the type of photodiode incorporated into a fiber optic detector, its performance depends upon a precise alignment of the optical fiber to the photodiode. A photodiode has an active area that reacts to light to produce electrical carriers. Because of edge effects, the edge of the active area may have a greater responsivity to light than the active area's center. Alternatively, depending upon the photodiode's construction, the responsivity may be approximately constant across the active region. During the alignment of an optical fiber to a photodiode, the increased responsivity caused by an optical fiber being aligned with the edge of the active area may fool a manufacturer into believing that the alignment is optimal. However, the edge of the active area responds much more slowly than the center so that an edge-aligned photodetector will “smear” the bit transitions in the received signal. Thus, an optical fiber must be carefully aligned with the center of a photodiode's active area for proper operation.

This alignment is hampered by the components' miniature dimensions. The core of a single-mode optical fiber typically has a diameter of between 8 and 9 microns. The center region of a photodiode's active area is only slightly larger, typically being about 25 microns in diameter. Performing the alignment manually is quite slow, labor intensive, and error prone. Because of the close tolerances, automated assembly equipment that have been developed to perform this alignment are quite expensive. Regardless of whether an automated or manual process is used, a proper alignment is an active process in that the photodiode must be powered and responding to a light signal from the optical fiber's core during assembly. For example, in an automated process, the alignment apparatus moves the optic fiber in a preset pattern with respect to the photodiode until the detected signal strength and response speed are maximized. The fiber and photodiode are then fixed into place.

Accordingly, there is a need in the art for improved fiber alignment techniques for photodetectors.

### SUMMARY

In accordance with one aspect of the invention, an integrated fiber alignment photodiode is provided including: a first substrate including a photodiode, the photodiode having an optically-active area; and a second substrate having a through hole defined through the substrate, the second substrate being bonded to a surface of the first substrate such that the through hole is aligned with the optically-active area, the through hole having a cross section sized to accept an optical fiber.

In accordance with another aspect of the invention, a wafer-scale fiber alignment photodiode assembly is provided that includes: a first wafer including a plurality of photodiodes, each photodiode having an optically-active area, the optically-active areas being arranged according to a predetermined pattern; a second wafer including a plurality of through holes defined through the second wafer, the through holes being arranged according to the arrangement of the optically-active areas such that each through hole corresponds on a one-to-one basis with an optically-active area, the second wafer being bonded to a surface of the first wafer such that each through hole is aligned with the corresponding optically-active area, each through hole having a cross section sized to accept an optical fiber.

### BRIEF DESCRIPTION OF THE DRAWINGS

FIG. 1 is a plan view of a wafer including a plurality of photodiodes.

FIG. 2 is a plan view of a silicon wafer having a plurality of through holes arranged according to correspond to the arrangement of photodiode active areas shown in FIG. 1.

FIG. 3 is an expanded view of the attachment of the wafer of FIG. 2 to the wafer of FIG. 1 from the silicon side.

FIG. 4a is a cross-sectional view of a fiber alignment photodiode coupled to an optical fiber using a through hole with a trapezoidal cross section in accordance with an embodiment of the invention.

FIG. 4b is a cross-sectional view of a fiber alignment photodiode coupled to an optical fiber using a through hole with a uniform cross section in accordance with an embodiment of the invention

Embodiments of the present invention and their advantages are best understood by referring to the detailed description that follows. It should be appreciated that like reference numerals are used to identify like elements illustrated in one or more of the figures.

### DETAILED DESCRIPTION

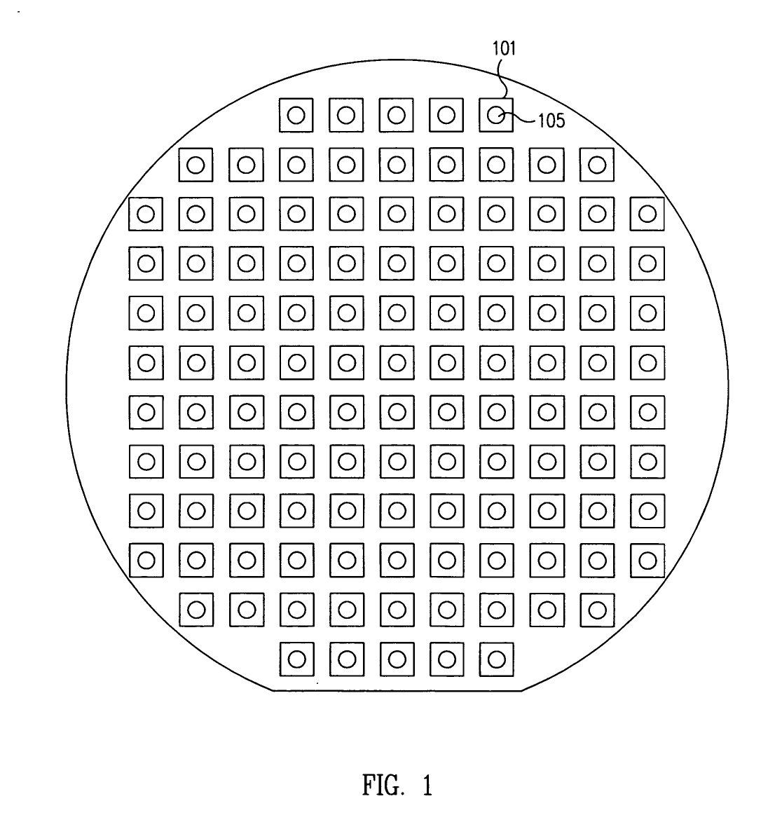

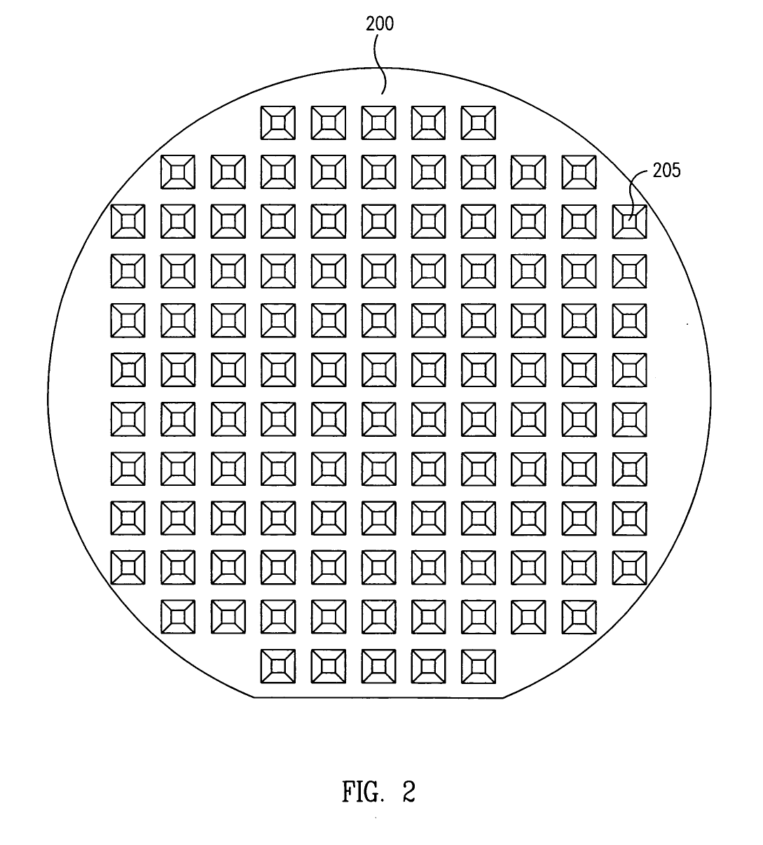

Referring now to the drawings, the active side of an InP wafer 100 is shown in FIG. 1. As known in the arts, a plurality of photodiodes 101 are formed on wafer 100 using, for example, photolithography and epitaxial deposition techniques. Each photodiode 101 includes an active region 105 that requires alignment with an optical fiber during the manufacture of a fiber optic detector as discussed previously. The present invention exploits the regular and known arrangement of active regions 105 on wafer 100 through the provision of mechanical fiber alignments arranged accordingly. Referring now to FIG. 2, a silicon wafer 200 is shown having through holes 205 arranged according to the arrangement of active regions 105 in FIG. 1. Each through hole 205 provides a mechanical fiber alignment for the insertion of an optical fiber. As known in the art, either dry etch or wet etch micromachining techniques may be used to form through holes 205 in wafer 200.

Once through holes 205 have been etched into wafer 200, it may be bonded to a surface of wafer 100 so that optical fibers may be fixed within through holes 205. A number of bonding techniques may be used to bond wafers 100 and 200. For example, as known in the art, flip-chip bonding tools may be used to provide alignment tolerances of approximately 1 micron or less. Using either infra-red or mechanical alignment techniques, a flip-chip assembly tool would align wafer 200 so that through holes 205 are substantially centered with respect to active areas 205. A suitable adhesive such as an ultraviolet-light-curable optical epoxy bonds wafers 100 and 200 together.

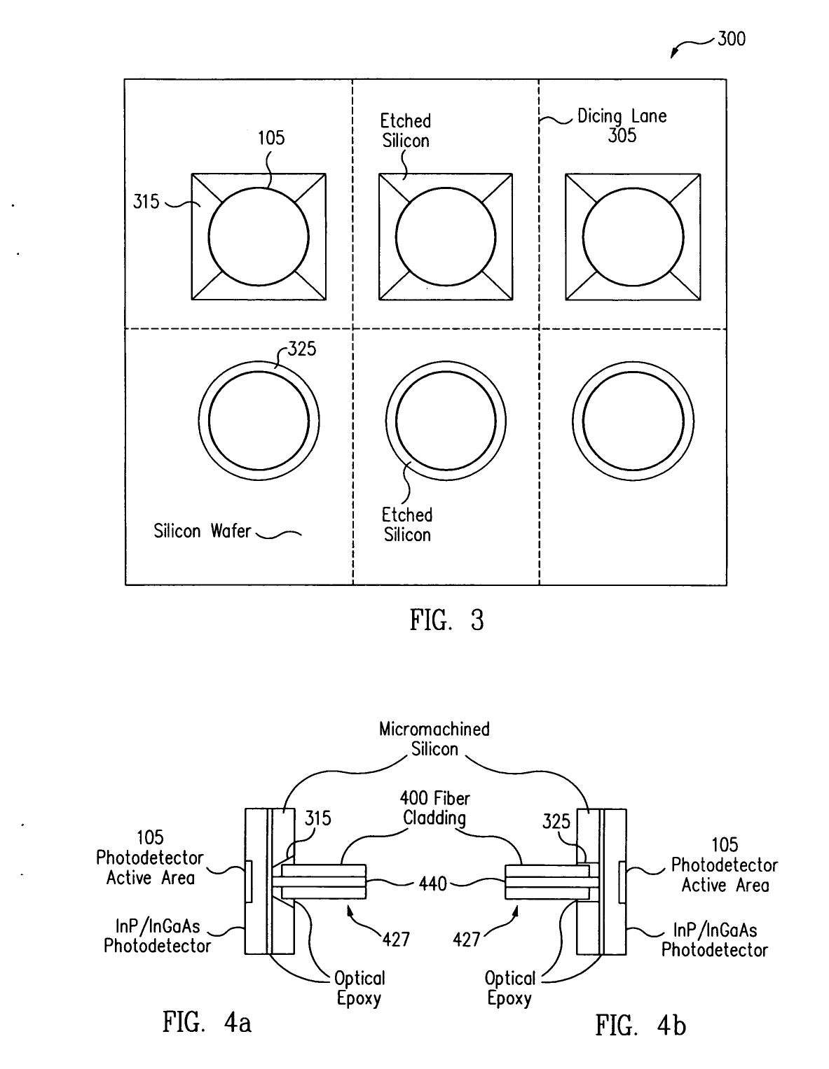

Once wafers 100 and 200 have been bonded together, individual die may be diced from the completed wafer. For example, an expanded view of the silicon side of a completed wafer 300 is shown in FIG. 3. By dicing wafer 300 along dicing lanes 305, individual integrated fiber alignment photodetectors 310 may be formed. As known in the art, either a high-powered laser or a dicing saw may be used to perform the dicing. Individual integrated fiber alignment photodetectors may then be bonded to a circuit board substrate using, for example, flip chip bonding tools and techniques. Suitable flip-chip bonding tools are conventional in the art and manufactured, for example, by Suss MicroTec. Using standard manual micropositioners or automated micromanipulators such as those manufactured by the Newport Corporation, an optical fiber may then be inserted into the through hole which acts as a fiber alignment guide. After insertion, the fiber is glued into place using, for example, ultraviolet-light-curable adhesive.

The geometry of each through hole depends upon the etching process used. Should the silicon wafer have a (100) lattice orientation, a wet etch produces a through hole 315 having a trapezoidal cross section. Alternatively, a dry etch on silicon wafer 200 produces a through hole 325 having a constant diameter. A cross-sectional view of the resulting through holes is shown in FIGS. 4a and 4b. A wet-etched trapezoidal cross section through hole 315 is shown in FIG. 4a whereas a dry-etched constant cross section through hole 325 is shown in FIG. 4b. It will be appreciated that neither FIG. 3a nor 3b is drawn to scale in that the diameter of an optical fiber including the cladding 400 is typically larger than the diameter of photodetector active area 105. For example, the diameter across each fiber 427 is determined by the dimensions for a core 440 and cladding 400 and is typically around 125 microns. The diameter of active area 405 depends upon the size of core 340 in that active area 205 must be slightly larger to allow for alignment tolerances while still maintaining an adequate received signal. Thus, should core 440 be eight microns in diameter as is typical for a single-mode fiber, a corresponding active area 405 should be about 25 microns in diameter. Conversely, if core 440 has a diameter of 62 microns as is typical for a multi-mode fiber, a corresponding active area 205 should be about 75 microns in diameter.

The diameter of dry-etched through hole 325 should equal that of optical fiber 427 plus an acceptable tolerance. Wet-etched through hole 315 has a beginning diameter that is larger than its ending diameter. To receive optical fiber 427, the dimensions for the inner and outer diameters should be such that an intermediate diameter falling approximately half way between these inner and outer diameters also equals the diameter of optical fiber 427 plus an acceptable tolerance. As shown in FIGS. 4a and 4b, fiber 427 does not end in a flat cleave but instead has a protrusion of core 440. However, it will be appreciated that this is merely illustrative and that the appropriate ending for fiber 427 may require a flat cleave depending upon the application.

Those of ordinary skill in the art will appreciate that many modifications may be made to the embodiments described herein. For example, as seen in FIGS. 4a and 4b with cross reference to FIGS. 1 and 2, wafer 200 may be bonded to the opposing side of wafer 100 with respect to the side holding photodetector active areas 105. Such an arrangement provides for easier access in regards to wiring photodetectors 100. However, wafer 200 may alternatively be bonded to the same side of wafer 100 that holds photodetector active areas 105. Although such an arrangement would require vias or other means for the wiring of photodetectors 100, dispersive effects and other undesirable effects of propagating the light from optical fiber 427 through the photodetector substrate are minimized. Accordingly, although the invention has been described with respect to particular embodiments, this description is only an example of the invention's application and should not be taken as a limitation. Consequently, the scope of the invention is set forth in the following claims.

1. An integrated fiber alignment photodiode, comprising:
a first substrate including a photodiode, the photodiode having an optically-active area, and
a second substrate having a through hole defined through the second substrate, the second substrate being bonded with optical adhesive to a surface of the first substrate such that the through hole is aligned with the optically-active area, the through hole having a cross section sized to accept an optical fiber.

2. The integrated fiber alignment photodiode of claim 1, further comprising:
an optical fiber bonded within the through hole.

3. The integrated fiber alignment photodiode of claim 1, wherein the first substrate comprises InP.

4. The integrated fiber alignment photodiode of claim 1, wherein the second substrate comprises silicon.

5. The integrated fiber alignment photodiode of claim 2, wherein the cross section of the through hole is uniform.

6. The integrated fiber alignment photodiode of claim 5, wherein the cross section of the through hole is trapezoidal.

7. (canceled)

8. A wafer-scale fiber alignment photodiode assembly, comprising:
a first wafer including a plurality of photodiodes, each photodiode having an optically-active area, the optically-active areas being arranged according to a predetermined pattern;
a second wafer including a plurality of through holes defined through the second wafer, the through holes being arranged according to the arrangement of the optically-active areas such that each through hole corresponds on a one-to-one basis with an optically-active area, the second wafer being bonded with optical adhesive to a surface of the first wafer such that each through hole is aligned with the corresponding optically-active area, each through hole having a cross section sized to accept an optical fiber.

9. The wafer-scale fiber alignment photodiode assembly of claim 8, wherein each through hole has a uniform cross-section.

10. The wafer-scale fiber alignment photodiode assembly of claim 8, wherein each through hole has a trapezoidal cross-section.

11. The wafer-scale fiber alignment photodiode assembly of claim 8, wherein the first wafer comprises InP.

12. The wafer-scale fiber alignment photodiode assembly of claim 8, wherein the second wafer comprises silicon.

13-20. (canceled)
